(19) United States
(12) Patent Application Publication
(10) Pub. No.: US 2018/0144065 A1
(43) Pub. Date: May 24, 2018

(54) Method for Generating Visual Representations of Data Based on Controlled Natural Language Queries and System Thereof

(71) Applicant: Mahesh Yellai, Hyderabad (IN)

(72) Inventor: Mahesh Yellai, Hyderabad (IN)

(21) Appl. No.: 15/569,793

(22) PCT Filed: Jul. 20, 2015
(86) PCT No.: PCT/IN2015/000291

§ 371 Date: Oct. 27, 2017

(30) Foreign Application Priority Data
Apr. 29, 2015 (IN) 2197/CHE/2015

(51) Int. Cl. G06F 17/30

(52) U.S. Cl. CPC G06F 17/30976; G06F 17/30991; G06Q 10/10; G06F 17/30557; G06F 17/30451

(57) ABSTRACT

A method for generating visual representations of data based on controlled natural language queries (CNL) using a configured dictionary of keywords (and their synonyms) and data fields (and their synonyms); the method comprising steps of: receiving said query to cause a set of one or more processors to analyse the said query and translating it into an abstract syntax tree (AST); representing the formal interpretation of the CNL query to the user wherein under condition that the CNL query cannot be translated unambiguously into a single AST, multiple abstract syntax trees (ASTs), each representing one possible interpretation of the CNL query, are generated and presented back to the user in their CNL form for the user to select one among the suggestions as the intended query; converting the AST into a database query and executed against the underlying database to obtain the result; providing a visual representation first real result containing a first dataset obtained from the database, the first dataset answering a first sub query that forms part of the main query; provide one or more further visual representation of real result, the or each further real result containing a respective further dataset obtained from the database, the or each further dataset answering a respective further sub-query that forms part of the main query; and obtaining a final visual representation of main query from the dataset from the first and one or more further real result answering the main query.

### FIELD OF INVENTION

The present invention relates to computer implemented methods and system for obtaining a visual representation of result set answering a main query comprising a plurality of sub queries from a plurality of databases. The invention is particularly, and exclusively, directed to methods of obtaining visual representation of result sets using controlled natural language queries.

### BACKGROUND ART

Finding patterns in data is often challenging, requiring users to extract data from an underlying database by framing queries in a formal query language (such as SQL, XQuery etc) and then using charting tools to present the results in graphical form for easy analysis. Even though formal query languages are expressive and powerful, they are way too technical for non-technical or business users to learn and use. The process of querying is even more difficult if multiple databases must be consulted to obtain a complete answer. Not only must the queries be executed against multiple databases, but the data from different sources must be joined; and, if there are discrepancies, the user must decide which source is more reliable. The ability to quickly and effectively access data is important to individuals and business.

Accordingly, there is a need for systems, methods, that enable a person who does not have formal training to effectively search data sources. This invention is designed to overcome the challenges of formal query languages by letting users express their queries in a controlled natural language.

The graphical/visual presentation of data is greatly influenced by the type of graphical/visual means applied to make the presentation and layout properties of the graphical/visual means. For textual presentations the means may comprise text sections, headings, tables with columns and rows, etc. The layout properties may comprise font size, line spacing, etc. For graphical presentations the means may comprise different types of charts and diagrams such as bar charts, line charts, pie charts, scatter charts, radar diagrams and other known diagrams or charts based on graphical elements. The layout properties may comprise tick marker spacing on an axis, legend font size, etc.

In the prior art, a PCT publication WO 2004/031884 discloses sales management data analysis system and method for interpreting raw sales management data. A plurality of natural language questions are provided, wherein each of the natural language questions correspond to at least one database query. An at least one database is queried in accordance with a selected one of the plurality of natural language questions. A particular data set is created responsive to the querying of at least one database in accordance with the one of the plurality of natural language questions from the at least one database. And the particular data set is sent to a destination, the particular data set configured to be able to provide a particular visual interpretation thereof, wherein the particular visual interpretation is of a particular type.

Another prior art US 2002/0116176 A1 discloses semantic answering system and method, wherein the answering system enables a user to input a query and responds with answers. Server stores an indexed database of a plurality of S-A-O's (subject-action-object). User generates the query that includes query elements (A-0), (S-A), or (S-X-0), or element (S). The server identifies the database element S, 0, or A, or elements (A-0) associated with a respective knowledge base S-A-0 that includes the query element(s) in response to the server receiving the query and generates a natural language answer S-A-0 that includes the identified and the query elements(s) and transmits the answer to the user apparatus that provides an audio or visual response.

### SUMMARY OF THE INVENTION

Accordingly, there exists a need for a business intelligence tool, which allows a new user or new users to access available data from a plurality of databases in a meaningful and time efficient manner through controlled natural language queries.

The “Controlled Natural Languages” (CNLs) are subsets of natural languages, designed by restricting the grammar and vocabulary in order to reduce or eliminate ambiguity and complexity. And a “database” is a digital collection of data whose organization is based on aspects of reality.

In accordance with a first aspect of the invention there is provided; a computer implemented method and a computer program product for obtaining a dataset answering a main CNL query from a database using a configured dictionary of keywords (and their synonyms) and data fields (and their synonyms); the method comprising receiving said query to cause a set of one or more processors to analyse the said query and translating (without any ambiguity) it into an abstract syntax tree (AST), representing the formal interpretation of the CNL query and under condition that the CNL query cannot be translated unambiguously into a single AST, multiple abstract syntax trees (ASTs), each representing one possible interpretation of the CNL query, are generated and presented back as suggestions to the user in their CNL form for the user to select one among the suggestions as the intended query;

the AST is then converted into a database query and executed against the underlying database to obtain the result;

the result of the database query is presented back to the user as a visualization.

providing a visual representation first real result containing a first dataset obtained from the database, the first dataset answering a first sub query that forms part of the main query,

provide one or more further visual representation of real result, the or each further real result containing a respective further dataset obtained from the database, the or each further dataset answering a respective further sub-query that forms part of the main query,

and obtain a final visual representation of main query from the dataset from the first and one or more further real result answering the main query.

In accordance with other aspect of the present invention there is provided a system including a plurality of processors configured for generating visual representations of data based on controlled natural language queries (CNL) using a configured dictionary of keywords (and their synonyms) and data fields (and their synonyms), comprising: an application server comprising database sever; a communications network; a client computer;

a memory including a plurality of databases; wherein the application server, when executed, the said server performs the aforesaid method steps.

In accordance with other aspect of the present invention, the method and the computer program product may further comprise receiving an indication of the main query. The indication of the main query is preferably provided by, and thus received from, a user. The indication may be received via a computer apparatus. The indication of the main query may be provided by any suitable input or inputs by means of audio/voice or text or GUI. In embodiments the indication of the main query is received via a user interface. Preferably the user interface may be a web based interface.

In another exemplary embodiment of the present invention, the CNL main query may be indicated in various manners. In preferred embodiments the step of receiving an indication of the main query comprises receiving an indication of parameters of one or more, and preferably each, of the sub-queries that form part of the main query. Preferably the indication of the parameters of the one or more of the sub-queries is provided by, and thus received from, a user. The user may specify any or all of the parameters of a sub-query. The user may provide an indication of the relationship between the sub-queries and the main query e.g. the way in which the sub-queries (or the results/answers of the sub-queries) are to be combined to answer the main query, or this may be determined automatically by the system.

In preferred embodiments the results of the sub-queries are combined in a predefined manner to answer the main query e.g. through an intersection or union (of the results sets) of the sub-queries. In other words, the way in which the results of the sub-queries are combined is determined by the system based on the keywords and fields used in the CNL query. The way in which the results are combined may be predefined in that it is predefined for multiple main queries. Alternatively a user may specify the way in which the results are combined.

The method and the computer program product may further comprise the step of outputting a visual representation in the form of charts, maps and/or tables answering the main query. The visually represented dataset may be output in any manner and/or stored. Storage of the dataset may take place in any location or locations, and in any suitable memory. In some embodiments the dataset is stored in a user database separate from the main database.

### BRIEF DESCRIPTION OF THE ACCOMPANYING DRAWINGS

FIG. 1 illustrates different hardware components in the system in accordance with the present invention;

FIG. 2 illustrates a flow chart depicting a typical user workflow in accordance with the present invention;

FIG. 3 illustrates a screenshot of product accepting text input of user queries in accordance with the present invention;

FIG. 4 illustrates a screenshot of product displaying visualization in accordance with the present invention;

FIG. 5(a-e) illustrates the result set as per corresponding examples (1-5) in accordance with the present invention.

### DETAILED DESCRIPTION

Such as herein described there is a provided a method and computer program product configured for generating visual representations of data based on controlled natural language enabling, wherein the users are facilitated for finding patterns in data from a plurality of databases by asking questions in a controlled natural language. The method and the computer program herein is configured for translating the queries into statements in a formal query language. These formal query language statements are then executed against the underlying database. The results are collated and finally presented to the user in a visual representation (such as bar charts, pie charts, line charts, motion charts, etc); where the most appropriate visual representation is automatically chosen by the system based on the query.

In accordance with any of the aforesaid embodiments of the present invention, the result may be stored in the memory, and the method comprises storing the real result. The results may be stored in any memory, and may be stored in a volatile, or preferably non-volatile memory. They may be stored using any suitable data storage medium or media. In particularly preferred embodiments the results are stored using a set of one or more memory drives. Any suitable drive may be used, but preferably the or each drive is a solid state drive (SSD). Such drives have been found to be particularly useful for storing result tables, as SSDs may provide fast access to stored data. Alternatively or additionally the set of one or more memory drives may include an optical or magnetic drive or drives e.g. a hard drive or drives. Regardless of the storage medium used, the tables may be stored in any suitable manner, and may be stored in the database, or in a separate dedicated result table database. Particular advantages are obtained when the results are stored using one or more SSDs, and in a dedicated database. This allows the result table database to be separated from the main or other databases, which can then be stored using other forms of data storage media or drive, or SSDs of a lesser specification, as the demands on the data storage media may be lower.

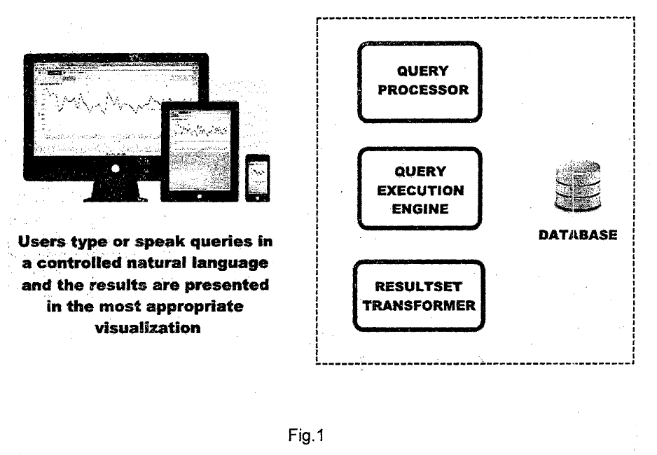

FIG. 1 illustrates the required hardware for executing the method as per an exemplary embodiment of the present invention. The hardware includes application server including database server, a communications network, a client computer and a plurality of databases. FIG. 1 shows an example of hardware for a standalone computer architecture that may be used to contain and/or implement the application instructions of system embodiments of the present invention. In addition to the standard computer-type components, the hardware may also include data input devices, such as a keyboard, or other input device, such as a microphone, remote control, pointer, mouse and/or joystick. The application server includes a processor, a data storage unit, and a network interface. The server runs a database application and a firewall. The firewall protects data stored in the data storage unit from unauthorized access by individuals and programs (sometimes called viruses). Further main components of the server are Query Processor, Query Execution Engine and Result set Transformer.

Query Processor is the component that is responsible for tokenizing and processing user-specified queries. It will map the query to a single AST or if unable to unambiguously map to one single AST, it will map to all possible ASTs and presents the user with the options so the user can choose one.

The AST is then passed to Query Execution Engine, which will compile a formal query language statement (in a form that is understood by the underlying database), from the AST and executes it against the underlying database.

The results are then passed to the Result set Transformer which will identify the most appropriate visualization (bar chart, pie chart, line chart, motion chart, etc) for the given query and transforms the results into a form suitable for rendering. The result set transformer can transform the results into display results in a plurality of visual formats as desirous to the user.

These components can be hosted either on the client-side computing device or on the server-side computer.

In another embodiment, the database application is a relational database or a NoSQL database or any other database which uses multiple sub databases/datastores for the organization of large data sources. In a further embodiment, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable, medium on a general- or specific-purpose machine, in firmware, in hardware, in a combination thereof, or in an applicable known or convenient device or system. Datastore-associated components, such as database interfaces, can be considered part of some other system component, or a combination thereof, though the physical location and other characteristics of datastore associated components is not critical for an understanding of the techniques described in the specification.

Datastores can include data structures. A data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. The datastores, described in this paper, can be cloud-based datastores. A cloud-based datastore is a datastore that is compatible with cloud-based computing systems and engines.

The query system applicable herein is pre-configured with a set of keywords (and their aliases or synonyms) which have semantics associated with them when converted to formal query language queries. Some examples of these keywords are: AVERAGE, TOP, LIST, COMPARE, DECILE DISTRIBUTION, PERCENTILE DISTRIBUTION, etc.

In addition, super users configure the system with the data dictionary for the underlying dataset. The data dictionary is like a database schema and captures, among other things, the fields in the dataset, their data types and their aliases or synonyms (that users are likely to refer the fields by). Examples of fields and aliases are: customer_name aliased as customer, customers; order_date aliased as purchased on, purchase date, order date, etc.

Users can specify their queries either through text input/speech input on a client device (a handheld computing device/a desktop/a laptop) and the results can be presented on a handheld computing device/a desktop/a laptop.

The user-specified query is tokenized; and the tokens are identified as a keyword or as a data field, based on the dictionary of keywords (and their synonyms) and the super user configured data dictionary of fields (and their synonyms). Based on the semantics associated with the keywords, the sequence of tokens is processed to map to a single formal query language query, which is represented within the system as an Abstract Syntax Tree (AST). If the system cannot unambiguously map the user-specified query to one single formal query language query, then the configured method maps it to all possible formal query language queries and their controlled natural language representations are presented back to the user for the user to pick one from among these options as the intended query.

Users start their queries with single word and refine them further by inputting additional words. As users input additional words, the system builds all possible ASTs for the additional words and merges them with the ASTs corresponding to the already typed part of the query. The resulting merged ASTs are presented to the user as suggestions and the user picks one from among the options.

In an example the AST is a tree representation of the abstract syntactic structure of the query written in controlled natural language. For example:—a natural language question is

What is the average production and sales today? The AST will break the query into:

What is the average production today? Sub Query 1

What is the average sales today? Sub Query 2

average production and sales today—Final result set

The statement in formal query language is executed against the underlying database. The most appropriate visualization, given the user-specified query, is identified and the results are rendered as the identified interactive visualization. The method also supports user-defined keywords. These keywords are defined as procedures or functions in a programming language. They take the query results as input and return filtered and/or aggregated and/or transformed results as output.

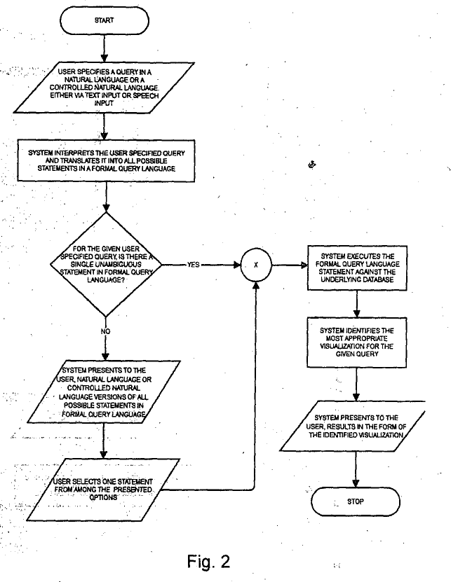

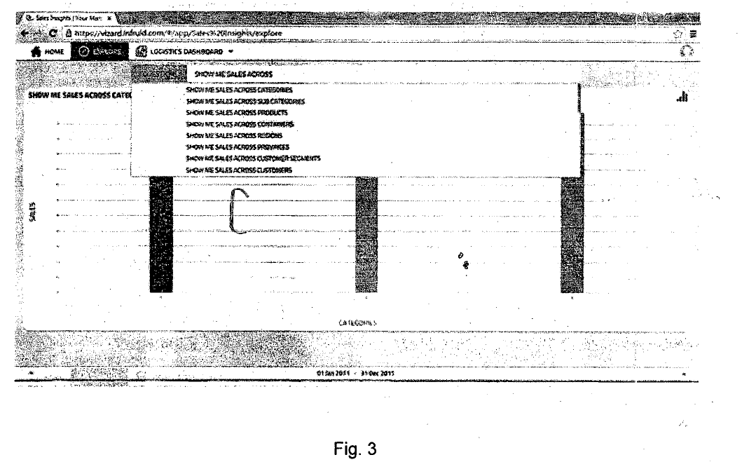

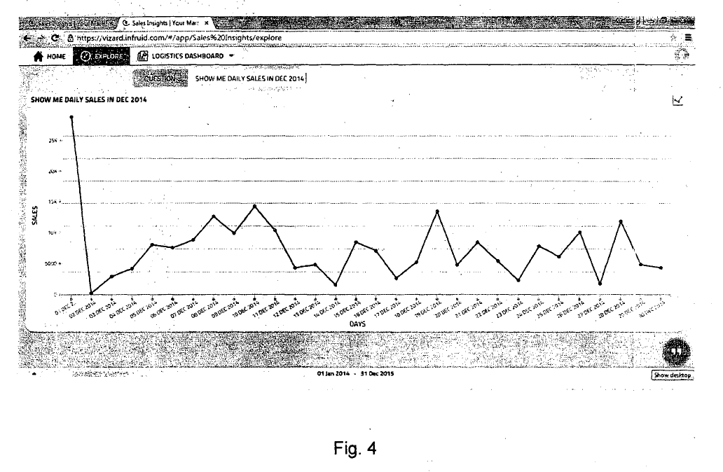

As shown in FIG. 2, the query processor maps the query to a single AST or if unable to unambiguously map to one single AST, it will map to all possible ASTs and presents the user with the options so the user can choose one. The AST is then passed to Query Execution Engine, which will compile a statement from the AST and executes it against the underlying database. The results are then passed to the Result set Transformer which will identify the most appropriate visualization (bar chart, pie chart, line chart, motion chart, etc) for the given query and transforms the results into a form suitable for rendering as shown in FIGS. 3 and 4 respectively as query and results. These components can be hosted either on the client-side computing device or on the server-side computer.

Alternatively, the results may be kept as permanent results, such that they may be used in future queries, avoiding the need to create new results each time a new query is encountered. This may provide some savings in terms of processing time. In the above example, the method might, rather than creating and filling a given real result, involve identifying an existing stored real result table which can be re-used in relation to the given new subquery. This may be achieved by consideration of the derived table indicated by the SQL syntax, and determining whether an existing stored real result table has valid content to enable it to be reused as the real result table for a given new subquery. This example is similar to that described above, but additionally shows the way in which a “UNION” statement is used to combine two datasets to provide the first dataset. Furthermore, this example involves intersecting only two datasets, and hence only involves creating two real result.

In another embodiment, the method includes voice-to-text transformation device or/and software system, software module configured to transform the recorded voice to a text format. The text is processed by the query processor into an AST and thereby executed against the underlying database.

In another embodiment, the query processor receives an instruction to perform a database operation involving a query. Based on an identification of a correlated subquery within the query, the query processor modifies the correlated subquery by replacing at least one correlated variable with a parameter. The modified subquery is sent by the query processor to an external database for execution, where the external database is identified in the correlated subquery. The results of the modified subquery are received by the query execution engine from the external database, and the result set transformer combines the results from the external database.

Some example queries are explained for understanding.

### Example 1

Controlled Natural Language Query: SHOW TOP 10 PRODUCTS BY SALES

This gets mapped to a DB query to get top 10 products ordered by their total sales.

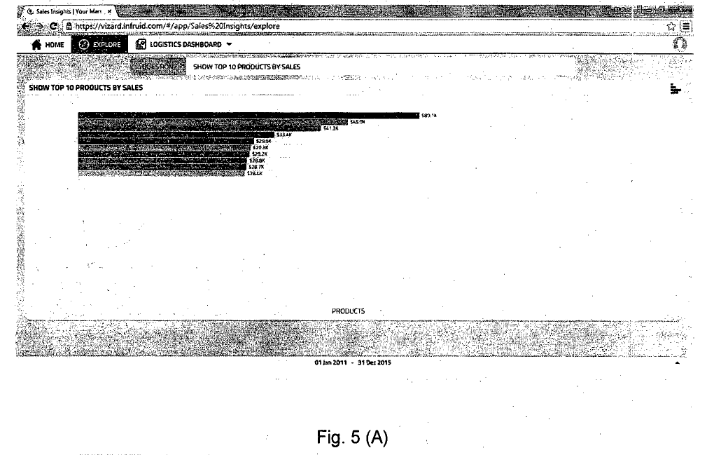

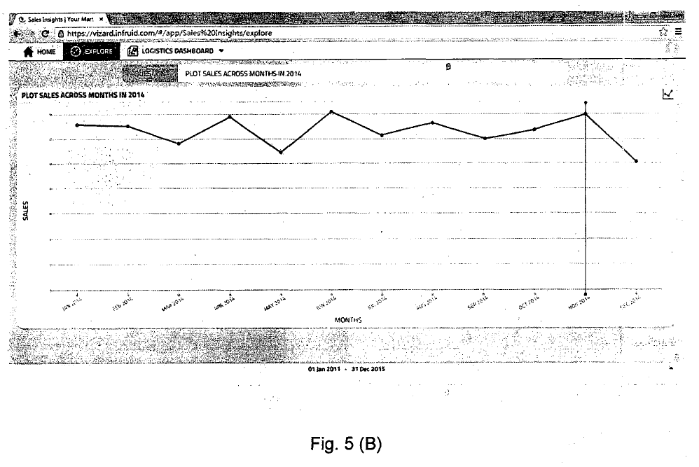

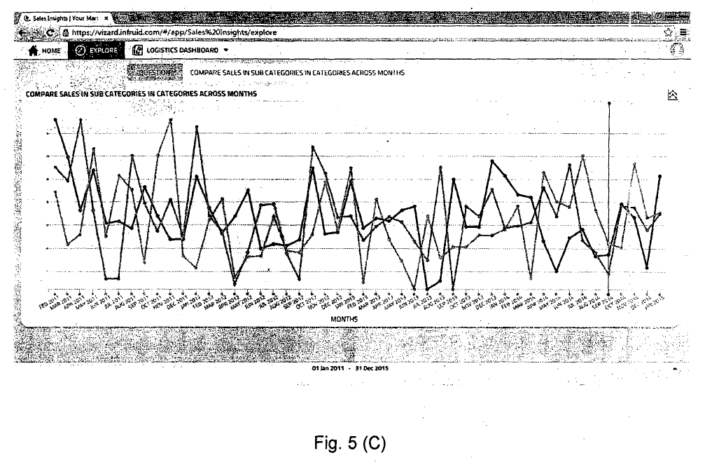

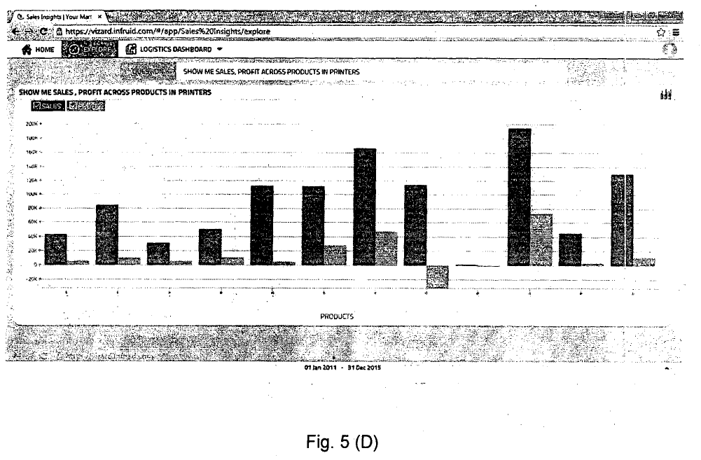

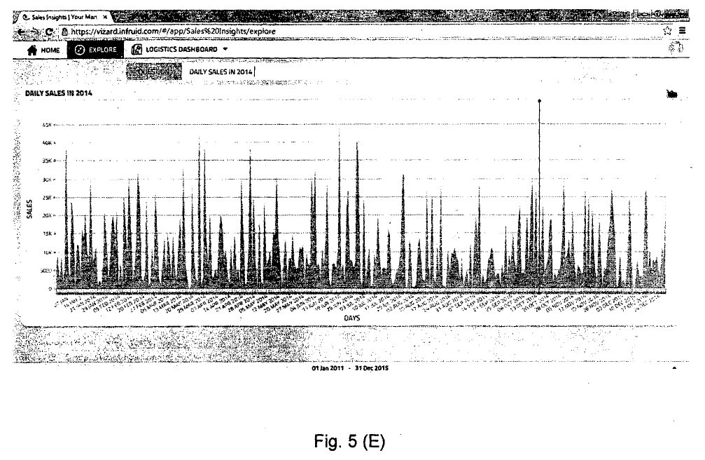

The result set FIG. 5(a) is displayed as a horizontal bar chart.

### Example 2

Controlled Natural Language Query: PLOT SALES ACROSS MONTHS IN 2014

This gets mapped to a DB query to get total sales in each month in year 2014.

The result set FIG. 5(b) is displayed as a line chart with months on x-axis and total sales on y-axis.

### Example 3

Controlled Natural Language Query: COMPARE SALES IN SUB CATEGORIES IN CATEGORIES ACROSS MONTHS

This gets mapped to a DB query to get sales in each category and sub category in each month.

The result set FIG. 5(c) is displayed as a multi-line chart with months on x-axis and total sales on y-axis, with each line representing a category and when the line is clicked on, the chart displays sub-category wise sales in the clicked (selected) category.

### Example 4

Controlled Natural Language Query: SHOW ME SALES, PROFITS ACROSS PRODUCTS IN “COPIERS AND FAX”

This gets mapped to a DB query to get total sales and profits for each product in “Copiers and Fax” sub category.

The result set FIG. 5(d) is displayed as a clustered bar chart for each product one bar showing sales and another bar showing profits.

### Example 5

Controlled Natural Language Query: DAILY SALES IN 2014

This gets mapped to a DB query to get sales in each day of 2014.

The result set FIG. 5(e) is displayed as an area chart showing sales across each day of 2014.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What claimed is:

1. A method for generating visual representations of data based on controlled natural language queries (CNL) using a configured dictionary of keywords (and their synonyms) and data fields (and their synonyms); the method comprising steps of:
receiving said query to cause a set of one or more processors to analyse the said query and translating it into an abstract syntax tree (AST);
representing the formal interpretation of the CNL query to the user wherein under condition that the CNL query cannot be translated unambiguously into a single AST, multiple abstract syntax trees (ASTs), each representing one possible interpretation of the CNL query, are generated and presented back to the user in their CNL form for the user to select one among the suggestions as the intended query;
converting the AST into a database query and executed against the underlying database to obtain the result;
providing a visual representation first real result containing a first dataset obtained from the database, the first dataset answering a first sub query that forms part of the main query;
provide one or more further visual representation of real result, the or each further real result containing a respective further dataset obtained from the database, the or each further dataset answering a respective further sub-query that forms part of the main query; and
obtaining a final visual representation of main query from the dataset from the first and one or more further real result answering the main query.

2. A method for generating visual representations of data based on controlled natural language queries as claimed in claim 1, wherein the method further comprise the step of:
receiving an indication of the main query wherein the indication of the main query is preferably provided by user.

3. A method for generating visual representations of data based on controlled natural language queries as claimed in claim 2, wherein the indication of the main query may be provided by any suitable input or inputs by means of audio/voice or text or GUI.

4. A method for generating visual representations of data based on controlled natural language queries as claimed in claim 2, wherein the step of receiving an indication of the main query comprises receiving an indication of parameters of one or more, and preferably each, of the sub-queries that form part of the main query.

5. A method for generating visual representations of data based on controlled natural language queries as claimed in claim 4, wherein the user specifies any or all of the parameters of a sub-query or provides an indication of the relationship between the sub-queries and the main query.

6. A method for generating visual representations of data based on controlled natural language queries as claimed in claim 1, wherein the results of the sub-queries are combined through an intersection or union of the results sets of the sub-queries.

7. A method for generating visual representations of data based on controlled natural language queries as claimed in claim 1, wherein the user specifies the way in which the results are combined.

8. A method for generating visual representations of data based on controlled natural language queries as claimed in claim 1, wherein the method comprise further step of outputting a visual representation in the form of charts, maps and/or tables answering the main query.

9. A method for generating visual representations of data based on controlled natural language queries as claimed in claim 1, wherein the result dataset is output in any manner and/or stored in any location or locations, and in any suitable memory.

10. A method for generating visual representations of data based on controlled natural language queries as claimed in claim 1, wherein the dataset is stored in a user database separate from the main database.

11. A system for generating visual representations of data based on controlled natural language queries (CNL) using a configured dictionary of keywords (and their synonyms) and data fields (and their synonyms), comprising:
an application server;
a database server;
a communications network;
a client computer;
a memory including a plurality of databases; wherein
the application server being setup for receiving said query to cause a set of one or more processors to analyse the said query and translating it into an abstract syntax tree (AST);
representing the formal interpretation of the CNL query to the user wherein under condition that the CNL query cannot be translated unambiguously into a single AST, multiple abstract syntax trees (ASTs), each representing one possible interpretation of the CNL query, are generated and presented back to the user in their CNL form for the user to select one among the suggestions as the intended query;
converting the AST into a database query and executed against the underlying database to obtain the result;
providing a visual representation first real result containing a first dataset obtained from the database, the first dataset answering a first sub query that forms part of the main query;
provide one or more further visual representation of real result, the or each further real result containing a respective further dataset obtained from the database, the or each further dataset answering a respective further sub-query that forms part of the main query; and
obtaining a final visual representation of main query from the dataset from the first and one or more further real result answering the main query.

12. A system for generating visual representations of data based on controlled natural language queries as claimed in claim 11, wherein the components of the server are Query Processor, Query Execution Engine and Result set Transformer.

13. A system for generating visual representations of data based on controlled natural language queries as claimed in claim 12, wherein Query Processor is the component configured for tokenizing and processing user-specified queries, constructing ASTs from processed queries and converting ASTs to database specific queries.

14. A system for generating visual representations of data based on controlled natural language queries as claimed in claim 11, wherein the query execution engine executes database specific queries against the underlying database or databases through firewall.

15. A system for generating visual representations of data based on controlled natural language queries as claimed in claim 12, the result set transformer is configured to display results in a plurality of visual formats.

16. A computer program product comprising:
a computer readable storage medium having computer readable program code embodied therewith, the computer readable program code comprising:
computer readable program code configured to convert the AST into a database query and executed against the underlying database to obtain the result;
computer readable program code configured to provide a visual representation first real result containing a first dataset obtained from the database, the first dataset answering a first sub query that forms part of the main query;
computer readable program code configured to provide one or more further visual representation of real result, the or each further real result containing a respective further dataset obtained from the database, the or each further dataset answering a respective further sub-query that forms part of the main query; and
computer readable program code configured to obtain a final visual representation of main query from the dataset from the first and one or more further real result answering the main query.

17. A computer program product configured for generating visual representations of data based on controlled natural language queries as claimed in claim 16, wherein the computer readable program code is configured to receive an indication of the main query wherein the indication of the main query is preferably provided by user.

18. A computer program product configured for generating visual representations of data based on controlled natural language queries as claimed in claim 17, wherein the indication of the main query may be provided by any suitable input or inputs by means of audio/voice or text or GUI.

19. A computer program product configured for generating visual representations of data based on controlled natural language queries as claimed in claim 17, wherein receiving an indication of the main query comprises receiving an indication of parameters of one or more, and preferably each, of the sub-queries that form part of the main query.

20. A computer program product configured for generating visual representations of data based on controlled natural language queries as claimed in claim 19, wherein the user specifies any or all of the parameters of a sub-query or provides an indication of the relationship between the sub-queries and the main query.

21. A computer program product configured for generating visual representations of data based on controlled natural language queries as claimed in claim 16, wherein the results of the sub-queries are combined through an intersection or union of the results sets of the sub-queries.

22. A computer program product configured for generating visual representations of data based on controlled natural language queries as claimed in claim 16, wherein the user specifies the way in which the results are combined.

23. A computer program product configured for generating visual representations of data based on controlled natural language queries as claimed in claim 16, wherein the computer readable program code is configured to output a visual representation in the form of charts, maps and/or tables answering the main query.

24. A computer program product configured for generating visual representations of data based on controlled natural language queries as claimed in claim 16, wherein the result dataset is output in any manner and/or stored in any location or locations, and in any suitable memory.

25. A computer program product configured for generating visual representations of data based on controlled natural language queries as claimed in claim 16, wherein the dataset is stored in a user database separate from the main database.
